(19) United States
(12) Patent Application Publication
(10) Pub. No.: US 2004/0077336 A1
(43) Pub. Date: Apr. 22, 2004

(54) Method and system for informing a person that a WLAN is accessible

(75) Inventor: Jean-Michel Lauriol, Fegersheim (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/664,867

(22) Filed: Sep. 22, 2003

(30) Foreign Application Priority Data
Oct. 22, 2002 (EP) 02 360 289.9

(51) Int. Cl. H04Q 7/24; H04M 1/66; H04M 1/68; H04M 3/16

(52) U.S. Cl. 455/411; 455/41.2; 455/426.1; 370/338

(57) ABSTRACT

The present invention concerns a method for informing a person that he or she can access to a WLAN, said person carrying or being associated with a mobile data terminal and a radiotelephone terminal.

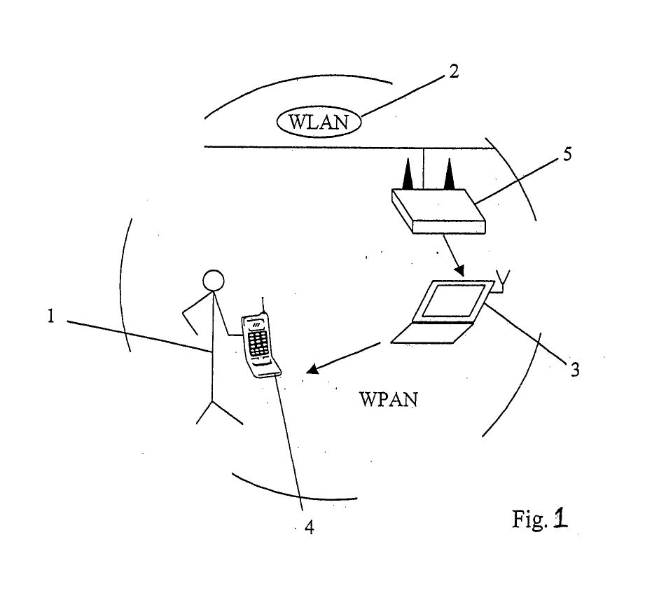

Said method is characterised in that it consists in:

first detecting the presence of the WLAN, by receiving identity or presence signals broadcasted by a or the radio access point of the considered WLAN, with a radio receiver associated to or integrated in said mobile data terminal and which is adapted and susceptible to receive radio signals broadcasted by a WLAN, and, then sending a signal or a message, via a short range radio transmitter, to said radiotelephone terminal equipped with an adapted receiver, in order to inform said person that he or she can access to said WLAN.

### TECHNICAL FIELD

The present invention is related to the field of telecommunications, more particularly to the detection procedures of and to the accessing procedures to wireless local area networks (WLANs), and concerns a method for informing of the possibility to access to a WLAN, and a system able to perform such a method. The invention is based on a priority application EP 02 360 289.9 which is hereby incorporated by reference.

### BACKGROUND OF THE INVENTION

Today, WLAN technology is rapidly spreading and is more and more considered in Public environments. WLAN access points are being deployed in public hotspots such as airports, hotels, train stations, conference centers or similar.

They allow a mobile WLAN user to access Internet services or Intranet company services through PDA or laptop computers equipped with a WLAN card.

These Public WLANs can be managed by WISP (Wireless Internet Service Provider) and/or Mobile Operator, even the site owner with the dedicated agreements between these business entities.

The problem today is that only few WLAN areas are deployed with limited radio coverage area. When a mobile user arrives in a public area, he or she does not know if a public WLAN access exists and where it could be located in this hotspot.

The technical problem to be solved by the invention is to signal/notify the mobile user that public or non public WLAN services are available in a specific area.

Indeed, the solution nowadays for the mobile user is to know exactly in which public areas WLANs are deployed in the world through documentation paper lists. It needs therefore a frequent search effort and a huge accuracy since, for example, only a restricted areas are covered, such as within a airport (dedicated lounges, coffee bars, . . . ).

WO 01/01711 describes a partial solution to the problem exposed beforehand, wherein a teleoperator notifies a user through a SMS message that a WLAN is available near said user. This detection and notification is performed, automatically or on demand, using location services.

Nevertheless, this notification is not carried out in real time and uses stored information, without verifying the real existence of the WLAN, nor the availability of said latter for the concerned user.

### SUMMARY OF THE INVENTION

The purpose of the present invention is to overcome these drawbacks.

To this effect, the present invention concerns a method for informing a person that he or she can access to a WLAN, said person carrying or being associated with a mobile data terminal and a radiotelephone terminal, method characterised in that it consists in:

first detecting the presence of the WLAN, by receiving identity or presence signals broadcasted by a or the radio access point of the considered WLAN, with a radio receiver associated to or integrated in said mobile data terminal and which is adapted and susceptible to receive radio signals broadcasted by a WLAN, and,

then sending a signal or a message, via a short range radio transmitter, to said radiotelephone terminal equipped with an adapted receiver, in order to inform said person that he or she can access to said WLAN.

Beforehand, said mobile data terminal is put in a mode (preferably with low power consumption) in which it scans periodically, preferably at (a) given frequency(ies) or within a given frequency range, for the existence of an identity or a presence signal from a WLAN for which the considered person is a potential user.

Advantageously, the scanning for an available WLAN is based on detection of a or the network identifier broadcasted by the or a WLAN to which the concerned person has subscribed.

According to an other feature of the invention, a successful detection of a WLAN to which the concerned person has subscribed can also be notified directly by the mobile data terminal, by means of an audio signal and/or a visual message displayed on its screen.

In relation with a preferred embodiment, the mobile data terminal and the radiotelephone terminal are equipped with wireless personal area network interfaces, such as so-called IrDa and Bluetooth interfaces.

The present invention also concerns a portable communication system able to inform a person that he or she can access to a WLAN, said system comprising a mobile data terminal and a radiotelephone terminal, characterised in that said mobile data terminal is associated with or integrates, on the one hand, a radio receiver which is adapted and susceptible to receive identity or presence radio signals broadcasted by a or the radio access point of the considered WLAN and, on the other hand, a short range radio transmitter, able to send a signal or a message in order to inform said person that he or she can access to said WLAN and in that said radiotelephone terminal is equipped with a receiver adapted to receive the signal or message sent by said short range transmitter of said mobile data terminal.

This system is advantageously able to perform the method described herein before.

### BRIEF DESCRIPTION OF THE DRAWINGS

This invention will be better understood thanks to the following description explaining a preferred embodiment of the invention as a non limitative example, in connection with the enclosed schematical drawing of a WLAN public access area, also illustrating a system performing the method according to the invention.

### DETAILED DESCRIPTION OF PREFERRED EMBODIMENTS

As shown on the enclosed figure, the method for informing a person 1 that he or she can access to a WLAN 2 mainly consists in:

first detecting the presence of the WLAN 2, by receiving identity or presence signals broadcasted by a or the radio access point 5 of the considered WLAN 2, with a radio receiver associated to or integrated in said mobile data terminal 3 and which is adapted and susceptible to receive radio signals broadcasted by a WLAN, and,

then sending a signal or a message, via a short range radio transmitter associated to said terminal 3, to said radiotelephone terminal 4 equipped with an adapted receiver, in order to inform said person 1 that he or she can access to said WLAN 2.

The mobile data terminal 3, such as a laptop computer or a PDA (Personal Digital Assistant), is in stand-by mode or in an operational mode and in these modes, the laptop/PDA scans periodically if the (public) WLAN is existing (based on detection of the subscriber Network Identifer—for example SSID in the IEEE 802.11 standard). If it exists, the laptop/PDA notifies immediately the user of the mobile phone, through the WPAN, that a real public access, associated to his subscription, is deployed and also on the laptop/PDA screen.

Thus, the user knows, without effort, that an available WLAN can be accessed from his or hers present place and can connect straigh away without any further checking.

The present invention is, of course, not limited to the preferred embodiments described herein and showed on the attached drawing, changes can be made or equivalents used without departing from the scope of the invention.

1) Method for informing a person that he or she can access to a WLAN, said person carrying or being associated with a mobile data terminal and a radiotelephone terminal, method wherein it consists in:
first detecting the presence of the WLAN, by receiving identity or presence signals broadcasted by a or the radio access point of the considered WLAN, with a radio receiver associated to or integrated in said mobile data terminal and which is adapted and susceptible to receive radio signals broadcasted by a WLAN, and,
then sending a signal or a message, via a short range radio transmitter, to said radiotelephone terminal equipped with an adapted receiver, in order to inform said person that he or she can access to said WLAN.

2) Method according to claim 1, wherein it consists in putting beforehand said mobile data terminal in a mode in which it scans periodically, preferably at (a) given frequency(ies) or within a given frequency range, for the existence of an identity or a presence signal from a WLAN for which the considered person is a potential user.

3) Method according to anyone of claims 1 and 2, wherein the scanning for an available WLAN is based on detection of a or the network identifier broadcasted by the or a WLAN to which the concerned person has suscribed.

4) Method according to anyone of claims 1 to 3, wherein a successful detection of a WLAN to which the concerned person has suscribed is also notified directly by the mobile data terminal, by means of an audio signal and/or a visual message displayed on its screen.

5) Method according to anyone of claims 1 to 4, wherein the mobile data terminal and the radiotelephone terminal are equipped with wireless personal area network interfaces, such as IrDa and Bluetooth interfaces.

6) Portable communication system able to inform a person that he or she can access to a WLAN, said system comprising a mobile data terminal and a radiotelephone terminal, wherein said mobile data terminal is associated with or integrates, on the one hand, a radio receiver which is adapted and susceptible to receive identity or presence radio signals broadcasted by a or the radio access point of the considered WLAN and, on the other hand, a short range radio transmitter, able to send a signal or a message in order to inform said person that he or she can access to said WLAN and in that said radiotelephone terminal is equipped with a receiver adapted to receive the signal or message sent by said short range transmitter of said mobile data terminal.

7) System according to claim 6, wherein it is able to perform the method according to anyone of claims 1 to 5.
